(19) United States
(12) Patent Application Publication
(10) Pub. No.: US 2025/0180002 A1
(43) Pub. Date: Jun. 5, 2025

(54) Piston rod mechanism for air compressor and air compressor

(71) Applicant: Dongguan Active Tools Co., Ltd., Dongguan City (CN)

(72) Inventors: Wesley Jui Hung Hong, Dongguan City (CN); Qinglin Xe, Dongguan City (CN); Koon Fung Lam, Dongguan City (CN)

(21) Appl. No.: 18/964,071

(22) Filed: Nov. 29, 2024

(30) Foreign Application Priority Data
Nov. 30, 2023 (CN) 202323266544.6

(51) Int. Cl. F04B 39/00

(52) U.S. Cl. CPC F04B 39/0016; F04B 39/0022

(57) ABSTRACT

The present application discloses a piston rod mechanism for an air compressor, along with an air compressor. The piston rod mechanism for an air compressor comprises: a rod and a piston fixedly connected to an output end of the rod, wherein an air vent is provided within the piston, allowing air to communicate between one side of the piston facing towards the rod and the other side away from the rod; an intake valve disposed at the piston, wherein the intake valve is configured to switch between a closed position where the air vent is closed and an open position where the air vent is opened, the intake valve being made of an elastomeric material. Accordingly, the piston rod mechanism for an air compressor, as described in the present application, is capable of reducing noise during operation.

### CROSS-REFERENCE TO RELATED APPLICATIONS

This application claims priority from Chinese Patent Application No. 202323266544.6 filed Nov. 30, 2023, which is hereby incorporated by reference in its entirety.

### TECHNICAL FIELD

The present application relates to the field of automotive maintenance, specifically to a piston rod mechanism for an air compressor, and an air compressor equipped with such a piston rod mechanism for an air compressor.

### BACKGROUND ART

During vehicle operation, tires may occasionally encounter abnormal conditions such as deflation or damage. In such scenarios, prompt tire repair and inflation are often required, necessitating the use of an air compressor during the process.

Air compressors typically incorporate transmission mechanisms, for example, to convert motor rotation into reciprocating motion. There is an air compressor which generates significant noise during operation, adversely affecting user experience.

As such, it is imperative to thoroughly investigate and address the existing issues or drawbacks, including those mentioned above, to facilitate improvements.

### SUMMARY

The present application introduces a piston rod mechanism for an air compressor, capable of reducing noise during operation.

According to the piston rod mechanism for an air compressor introduced in one aspect of the present application, the piston rod mechanism comprises:
a rod and a piston fixedly connected to an output end of the rod, wherein an air vent is provided within the piston, allowing air to communicate between one side of the piston facing towards the rod and the other side away from the rod;
an intake valve disposed at the piston, the intake valve being configured to switch between a closed position where the air vent is closed and an open position where the air vent is opened, the intake valve being made of an elastomeric material.

According to the piston rod mechanism for an air compressor introduced in one aspect of the present application, a receiving portion is provided within the piston, configured to house the intake valve in the closed position.

According to the piston rod mechanism for an air compressor introduced in one aspect of the present application, the intake valve is secured to the piston via a pin shaft and is capable of oscillating relative to the piston with the pin shaft as a pivot.

According to the piston rod mechanism for an air compressor introduced in one aspect of the present application, a plurality of pin shafts are provided.

According to the piston rod mechanism for an air compressor introduced in one aspect of the present application, the receiving portion is disposed at an end of the piston.

According to the piston rod mechanism for an air compressor introduced in one aspect of the present application, a ball bearing is provided at an input end of the rod, with a piston ring provided on an outer periphery of the piston.

According to the piston rod mechanism for an air compressor introduced in one aspect of the present application, the intake valve is made of silicone, the rod is made of plastic, the ball bearing is made of metal, and the piston ring is made of rubber.

Moreover, the present application introduces an air compressor equipped with the aforementioned piston rod mechanism. The air compressor comprises the piston rod mechanism according to the present application, thereby inheriting the advantages described above.

According to the air compressor introduced in one aspect of the present application, the air compressor comprises a compression cylinder, wherein the output end of the rod is configured to drive the piston to reciprocate within the compression cylinder.

According to the air compressor introduced in one aspect of the present application, an exhaust valve is provided at an air outlet of the compression cylinder.

The beneficial effects of the present application comprise: the capability of effectively reducing noise of the air compressor during operation by setting up an intake valve at the piston and opting for an elastomeric material to make the intake valve.

### DESCRIPTION OF THE DRAWINGS

The disclosure of the present application is illustrated with reference to the accompanying drawings. It should be understood that the accompanying drawings are provided solely for illustrative purposes, rather than intended to limit the protection scope of the present application. In the accompanying drawings, unless otherwise specified, identical reference signs are devised to denote identical components, where:

FIG. 1 schematically illustrates the piston rod mechanism according to one embodiment of the present application, with the intake valve in the closed position.

FIG. 2 schematically depicts the intake valve of the piston rod mechanism shown in FIG. 1.

FIG. 3 schematically shows a portion of the piston rod mechanism from FIG. 1, with the intake valve removed.

### DETAILED DESCRIPTION

As is readily understood, according to the technical solutions of the present application, multiple interchangeable structural configurations and implementation means may be introduced by those skilled in the art, without altering the essence and spirit of the present application. Accordingly, the following detailed embodiments and the accompanying drawings are merely exemplary illustrations of the technical solutions of the present application, and should not be deemed exhaustive or as defining or limiting the technical solutions of the present application.

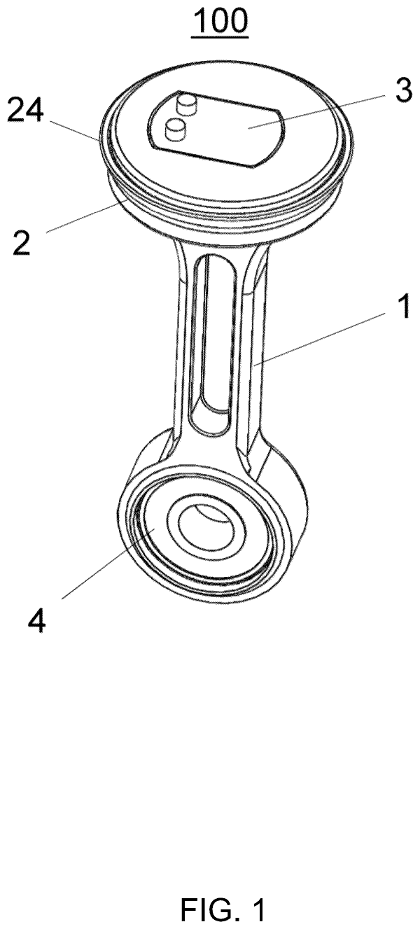

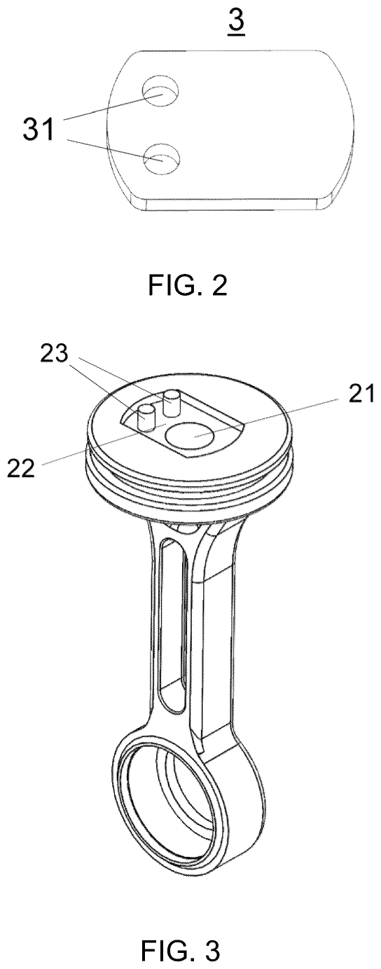

According to an embodiment of the present application, as illustrated in FIGS. 1 to 3, a piston rod mechanism 100 for an air compressor is shown, comprising a rod 1 and a piston 2 fixedly connected to an output end of the rod. The rod further comprises an input end configured to receive power, for example, from a motor, while the output end of the rod serves to transmit power to the piston. The piston, for example, is integrally formed with the rod. An air vent 21 is provided inside the piston, allowing air to communicate between one side of the piston facing towards the rod and the other side away from the rod. In other words, two chambers isolated by the piston within a compression cylinder can communicate via the air vent, where the air vent is configured, for example, as a hole extending through the piston in the extension direction of the rod.

The piston rod mechanism further comprises an intake valve 3 disposed at the piston, the intake valve being switchable between a closed position where the air vent is closed and an open position where the air vent is opened. The intake valve, which is made of an elastomeric material comprising elastic polymers. The intake valve made of an elastomeric material exhibits minimal vibration when switching between the closed and open positions.

In the embodiment shown in the figures, a receiving portion 22 is provided within the piston. The receiving portion is configured as a substantially square groove that matches the shape as which the intake valve is configured, and is intended to accommodate the intake valve in the closed position.

The intake valve 3 is secured to the piston via two pin shafts 23. The pin shafts, for example, are integrally formed with the piston. Inside the intake valve, two corresponding shaft holes 31 are provided, through which the two pin shafts 23 pass, thereby securing the intake valve. The intake valve, because of being made of an elastomeric material, can oscillate relative to the piston with the pin shafts as pivots. In the embodiment shown in the figures, the pin shafts extend perpendicularly to the surface of the piston. However, the pin shafts are not limited to the embodiment shown in the figures. For example, the pin shafts may extend parallel to the surface of the piston and be configured as the rotational axis of the intake valve. Certainly, the number of pin shafts may also be varied as required, for example, by providing multiple pin shafts.

In this manner, the intake valve is configured as a check valve. Specifically, when the piston moves in the direction towards an air outlet of the compression cylinder (the upward direction in the figures), the intake valve closes the air vent; when the piston moves in the direction away from the air outlet of the compression cylinder (the downward direction in the figures), the intake valve opens the air vent.

In the embodiment shown in the figures, the receiving portion is disposed at an end of the piston. Naturally, the receiving portion may also be disposed at other locations of the piston as required.

A ball bearing 4 is provided at the input end of the rod, with a piston ring 24 provided on the outer periphery of the piston. The ball bearing is connected to a power input member, such as a crankshaft pin, to convert the rotational motion of the motor into the oscillating motion of the rod and the reciprocating motion of the piston. The piston ring is used to seal the gap between the piston and the compression cylinder.

Exemplarily, the intake valve is made of silicone, the rod is made of plastic (such as PA66 or PA46 plastic), the ball bearing is made of metal, and the piston ring is made of rubber (such as NBR rubber)—Silicone is elastic and can reduce noise; PA66 or PA46 plastic has good temperature resistance as well as high strength; NBR rubber possesses sound sealability, along with wear-resistance; and metal also features both high strength and resistance to wear. In this way, while ensuring the normal operation of the piston rod mechanism, noise can be reduced and weight be lowered.

The present application also comprises an air compressor equipped with the piston rod mechanism for an air compressor illustrated in one or more of the aforementioned embodiments, which, accordingly, possesses technical features and effects corresponding to the preceding descriptions. For this reason, redundant details are not repeated here.

According to an embodiment of the present application, the air compressor comprises a compression cylinder, with an output end of the rod capable of driving the piston to reciprocate within the compression cylinder. An exhaust valve is provided at an air outlet of the compression cylinder, with the exhaust valve being configured as a check valve. Specifically, when the piston moves in the direction towards the air outlet of the compression cylinder, the exhaust valve opens the air outlet of the compression cylinder; when the piston moves in the direction away from the air outlet of the compression cylinder, the exhaust valve closes the air outlet of the compression cylinder.

An exemplary operating process of the air compressor is as follows: When the piston moves in the direction away from the air outlet of the compression cylinder, the exhaust valve in the air outlet closes, the volume of gas in the compression cylinder increases, and the pressure drops; atmospheric pressure pushes air into the compression cylinder through the intake valve; when the piston moves to the position furthest away from the air outlet of the compression cylinder, the volume of gas in the compression cylinder is maximized, and the pressure inside the compression cylinder balances with atmospheric pressure, causing no more air to enter, and the intake valve closes. When the piston moves in the direction towards the air outlet of the compression cylinder, the volume of gas in the compression cylinder decreases, pressure increases, and the exhaust valve in the air outlet of the compression cylinder is driven to open, allowing gas to enter the air outlet and pass through a throat tube into a tire. The cycle continuously repeats this way to achieve the purpose of inflating a car tire.

The technical scope of the present application is not limited to the content described above. Those skilled in the art may make various modifications and alterations to the above embodiments without departing from the technical concept of the present application. Such modifications and alterations shall be deemed within the present application.

What is claimed is:

1. A piston rod mechanism for an air compressor, wherein the piston rod mechanism comprising:
a rod and a piston fixedly connected to an output end of the rod, wherein an air vent is provided within the piston, allowing air to communicate between one side of the piston facing towards the rod and the other side away from the rod;
an intake valve disposed at the piston, wherein the intake valve is configured to switch between a closed position where the air vent is closed and an open position where the air vent is opened, the intake valve being made of an elastomeric material.

2. The piston rod mechanism for an air compressor according to claim 1, wherein a receiving portion is provided within the piston, configured to house the intake valve in the closed position.

3. The piston rod mechanism for an air compressor according to claim 1, wherein the intake valve is secured to the piston via a pin shaft and is capable of oscillating relative to the piston with the pin shaft as a pivot.

4. The piston rod mechanism for an air compressor according to claim 3, wherein a plurality of pin shafts are provided.

5. The piston rod mechanism for an air compressor according to claim 2, wherein the receiving portion is disposed at an end of the piston.

6. The piston rod mechanism for an air compressor according to claim 1, wherein a ball bearing is provided at an input end of the rod, with a piston ring provided on an outer periphery of the piston.

7. The piston rod mechanism for an air compressor according to claim 6, wherein the intake valve is made of silicone, the rod is made of plastic, the ball bearing is made of metal, and the piston ring is made of rubber.

8. An air compressor, comprising the piston rod mechanism for an air compressor according to claim 1.

9. The air compressor according to claim 8, wherein the air compressor comprising a compression cylinder, wherein the output end of the rod is configured to drive the piston to reciprocate within the compression cylinder.

10. The air compressor according to claim 9, wherein an exhaust valve is provided at an air outlet of the compression cylinder.
